(19) United States
(12) Patent Application Publication
(10) Pub. No.: US 2013/0015609 A1
(43) Pub. Date: Jan. 17, 2013

(54) FUNCTIONALLY GRADED ADDITIVE MANUFACTURING WITH IN SITU HEAT TREATMENT

(71) Applicant: Joel G. Landau, Simi Valley, CA (US)

(72) Inventor: Joel G. Landau, Simi Valley, CA (US)

(73) Assignee: Pratt & Whitney Rocketdyne, Inc., Canoga Park, CA (US)

(21) Appl. No.: 13/626,239

(22) Filed: Sep. 25, 2012

Related U.S. Application Data
(60) Provisional application No. 61/673,116, filed on Jul. 18, 2012.

(51) Int. Cl. B29C 35/08

(52) U.S. Cl. 264/497; 425/174.4

(57) ABSTRACT

According to one embodiment of this disclosure, a method for manufacturing a component includes providing a first layer of powdered particles onto a table. The method further includes selectively fusing the first layer of powdered particles by transmitting energy from an energy beam through the table.

### RELATED APPLICATIONS

This disclosure claims the benefit of U.S. Provisional Application No. 61/673,116, filed 18 Jul. 2012, the entirety of which is herein incorporated by reference.

### BACKGROUND

Powder bed additive manufacturing processes are known. In one known process, a layer of powdered particles is dispensed into a chamber, and an initial portion, or cross section, of a component is formed by fusing selected particles together. Then, a base is lowered, and another layer of powered particles is dispensed into the chamber. These powdered particles are selectively fused to the initial layer of fused particles, and the process repeats itself until the component is formed.

### BRIEF DESCRIPTION OF THE DRAWINGS

The drawings can be briefly described as follows:

FIG. 1 illustrates an example process for producing a component.

FIG. 2 schematically illustrates an example additive manufacturing machine.

FIG. 3 illustrates detail of the process of FIG. 1.

FIGS. 4A-4H schematically illustrate the steps in the processes illustrated in FIGS. 1 and 3.

### DETAILED DESCRIPTION

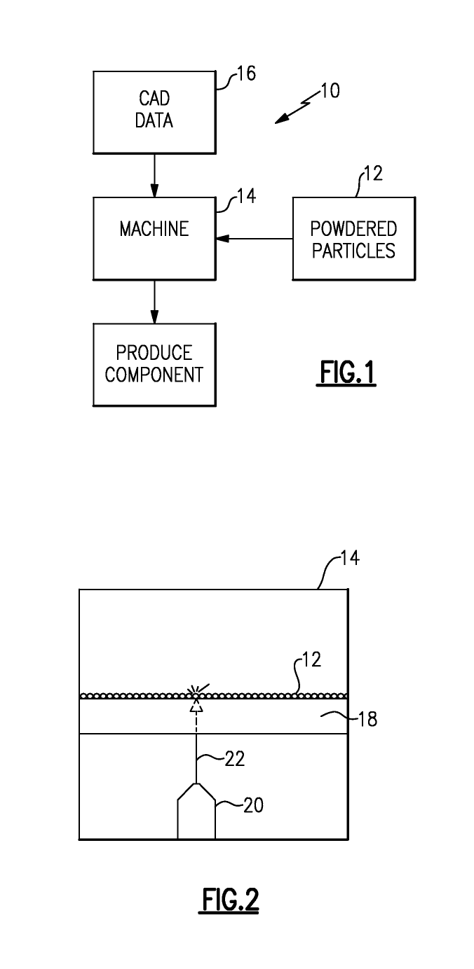

FIG. 1 illustrates an example additive manufacturing process 10. The process 10 can be used to form components having complex geometries, such as complex internal passages, that would be otherwise relatively difficult or impossible to produce using conventional, subtractive processing techniques. Examples of such components include components for rocket engines or gas turbine engines, however this disclosure is not limited to any particular component type. Further, this disclosure is not limited components made of a particular material type, and extends to components made from metal, polymers, ceramics, etc.

With further reference to FIG. 1, powdered particles 12 used for forming a component are provided within a machine 14. With respect to computer aided drafting (CAD) data 16, which represents a particular component geometry, a component is formed using additive manufacturing techniques, which will be explained in detail below.

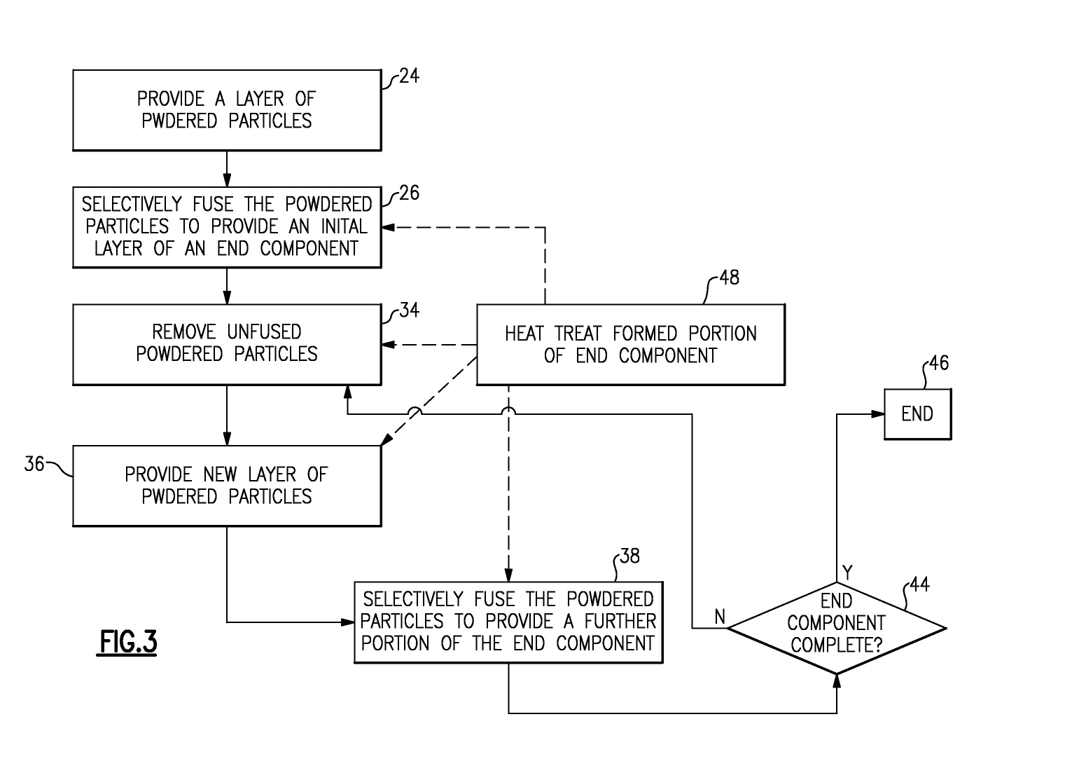

FIG. 2 schematically illustrates an example additive manufacturing machine 14. In the example, the powdered particles 12 are provided on an upper side, relative to the orientation of FIG. 2, of an at least partially translucent table 18. An energy beam source 20, which is configured to emit an energy beam 22, is provided on a lower side of the table 18. Example energy beams include lasers and electron beams.

The table 18 is made of a solid material which is at least partially translucent such that at least a portion, such as some wavelengths, of the energy beam 22 can pass through the table 18. This disclosure is not limited to any specific material type for the table 18, and a worker in this art can select a material having desired properties. Example materials include quartz, silicon nitride (SiN), aluminum silicon nitride (AlSiN), polymers, ceramics, and other strong and partially translucent materials.

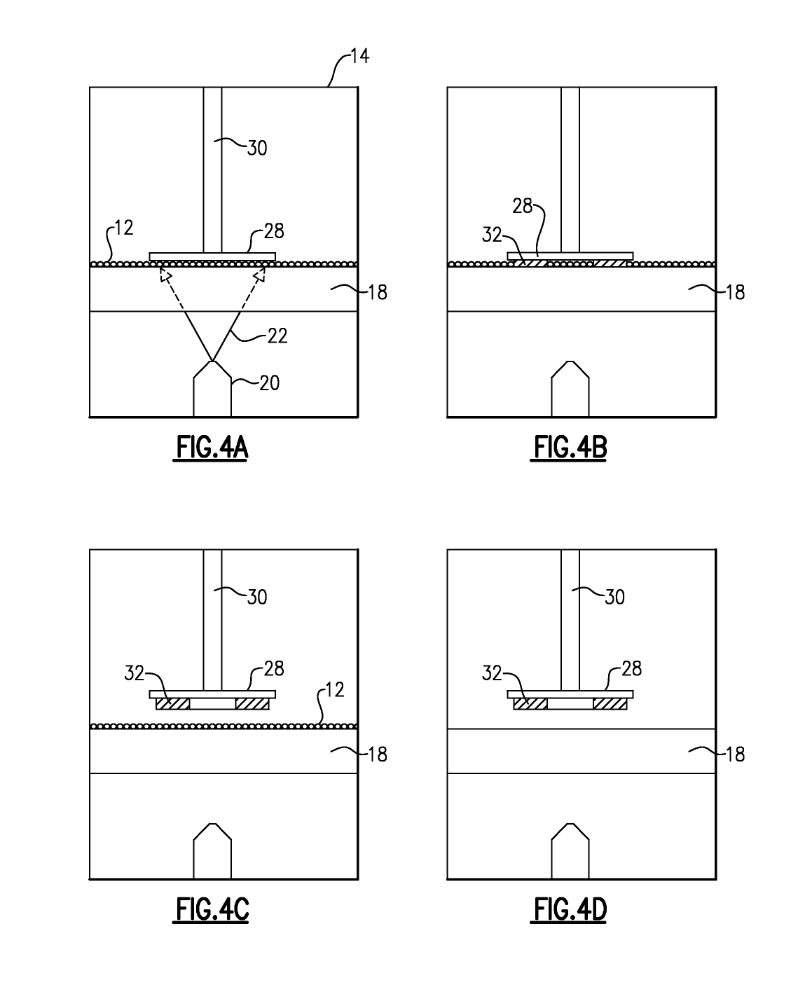

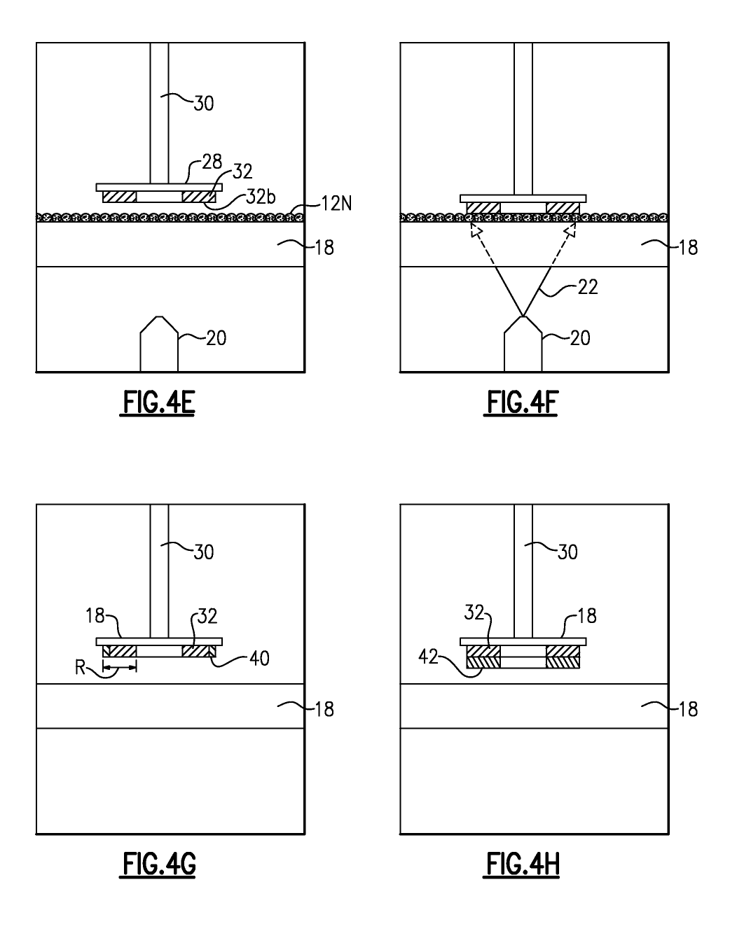

With continued reference to FIG. 2, and also with reference to FIGS. 3 and 4A-4H, an example method for forming a component is described. Initially, at 24, a first layer of powdered particles 12 is provided on an upper side of the table 18, as illustrated in FIG. 2. As represented in FIG. 4A, the energy beam 22 is activated, at 26, and selectively melts certain of the powdered particles 12 and a base 28 based at least in part with the CAD data 16. The base 28 may be disposed in close proximity to the powdered particles 12 such that the melting process creates a micro-weld pool of material consisting of both the powder and at least a portion of the base 28. Upon cooling, the combined micro-weld pool fuses into a single unitary part.

In the illustrated example of FIG. 4A, a base 28 is within the additive manufacturing machine. The base 28 is movable relative to the table 18 by way of a lifting mechanism 30. In this example, the base is positioned in close proximity to the powdered particles 12 during melting and fusing, and thus the powdered particles 12 are fused to the base 28.

As illustrated in FIG. 4B, a first cross section 32, which provides an initial portion of an end-use component (or part), has been fused to the base 28. In FIG. 4C, the base 28 and first cross section 32 are lifted relative to the table 18, by way of the lifting mechanism 30, and the powdered particles 12 are removed, at 34, as illustrated in FIG. 4D. The removed, unfused powdered particles can be recycled and used to form a subsequent portion of the end-use component, if desired.

At 36, a new layer of powdered particles 12N is provided onto the upper surface of the table 18, as illustrated in FIG. 4E. The new layer of powder particles 12N are optionally of a different chemical composition from the initial layer of particles 12 provided in FIG. 4A. This provides the option of forming the end-use component with a multi-composition, or functionally graded cross section. As is known in this art, functionally graded components change in composition (e.g., in chemical composition) in a particular direction, for example, thickness. Functionally graded components are discussed in U.S. Pat. No. 5,112,146 to Stangeland, the entirety of which is herein incorporated by reference.

As illustrated in FIG. 4F, the base 28 may be lowered such that the first cross section 32 is disposed in close proximity with the additional powdered particles 12N, thereby enabling the additional powdered particles 12N to be selectively fused, at 38, to the first cross section 32. In this embodiment the additional particles 12N provide the end-use component with an increased radial dimension R (by way of the added thickness 40) relative to the first cross section 32, as illustrated in FIG. 4G. The end-use component would thus have a functionally graded cross section. This process can be repeated, as desired, to provide the end-use component with desired properties. In one example, this process can be used to provide one side of the component with a relatively hard material, and the other side with a relatively strong material, which can lead to reduced cracking in the end-use component.

In another example, the additional particles 12N added at step 36 are fused to a bottom surface 32b of the first cross section 32, as shown in FIG. 4H, to add to the axial or vertical dimension of the end-use component. In the example of FIG. 4H, the additional particles need not have a different chemical composition from the initial particles 12. However, it is possible to use different materials between axial layers of the end-use component, as desired. The steps illustrated across FIGS. 4A-4H can be repeated as desired until the component is completed, as represented at 44 and 46.

In the above-described process, the exterior of the formed portion of the end-use component will be exposed throughout the process, whereas the formed portion of the end-use component in a typical additive manufacturing process would be buried in unfused powdered particles. Accordingly, in the disclosed example, it is possible to heat treat the formed portion of the end-use component, at 48, as desired throughout the manufacturing process. The heat treatment may be accomplished by defocusing the laser and radiating the exposed geometries of the part with periodic and/or continuous energy. Additional heat treat methods may include inductive heating, resistive heating, convection heating and other type of heating. This heat treatment can be characterized as “in situ,” because it can take place during other manufacturing steps. One contemplated heat treatment is annealing, wherein the end-use component is heated above a critical temperature, maintained at a suitable temperature, and then cooled. Given the above, components can be formed using different material types, to provide the end-use component with desired properties, including a functionally graded cross section. The components can further be heat treated, during machining, which saves time and other expenses relative to conventional techniques. Again, this disclosure, by virtue of employing an additive manufacturing technique, can further provide parts with relatively complex geometries.

Although the different examples have the specific components shown in the illustrations, embodiments of this disclosure are not limited to those particular combinations. It is possible to use some of the components or features from one of the examples in combination with features or components from another one of the examples.

One of ordinary skill in this art would understand that the above-described embodiments are exemplary and non-limiting. That is, modifications of this disclosure would come within the scope of the claims. Accordingly, the following claims should be studied to determine their true scope and content.

What is claimed is:

1. A method for manufacturing a component comprising:
providing a first layer of powdered particles onto a table; and
selectively fusing the first layer of powdered particles by transmitting energy from an energy beam through the table.

2. The method as recited in claim 1, wherein fusing the first layer of powdered particles provides a first cross section of the component.

3. The method as recited in claim 2, including providing a base in close proximity to the first layer of powdered particles such that the first cross section is provided onto the base.

4. The method as recited in claim 3, including moving the base relative to the table to allow removal of the unfused ones of the first layer of powdered particles.

5. The method as recited in claim 4, including removing unfused ones of the first layer of powdered particles from the table.

6. The method as recited in claim 5, including providing a second layer of powdered particles onto the table.

7. The method as recited in claim 6, wherein the second layer of powdered particles has a chemical composition different than the first layer of powdered particles.

8. The method as recited in claim 6, wherein the first layer of powdered particles and the second layer of powdered particles include powdered metal particles.

9. The method as recited in claim 6, including selectively fusing the second layer of powdered particles to the first cross section, by transmitting energy from an energy beam through the table, to provide a second cross section of the component.

10. The method as recited in claim 9, wherein providing the second cross section increases one of a radial dimension and an axial dimension of the component.

11. The method as recited in claim 9, including providing a set of data instructions for forming the component, the first layer of powdered particles and the second layer of powdered particles fused with respect to the set of data instructions.

12. The method as recited in claim 9, including heat treating an exterior of the first cross section of the component during the step of selectively fusing the second layer of powdered particles.

13. The method as recited in claim 12, wherein the heat treating includes annealing.

14. The method as recited in claim 1, including providing an energy beam source configured to emit the energy beam, the energy beam source positioned on a side of the table opposite a side of the table configured to support powdered particles.

15. The method as recited in claim 14, wherein the energy beam source is configured to generate one of a laser beam and an electron beam.

16. The method as recited in claim 1, wherein the table is made of a material capable of allowing at least some wavelengths of the energy beam to pass therethrough, the material being a solid material.

17. A manufacturing process comprising:
adding a layer of a first powder to a table, the table made of a translucent material;
disposing an external cross section of a partially formed part in proximity with the layer of the first powder;
selectively melting the first powder to fuse with the partially formed part, thereby providing the partially formed part with a new external cross section;
lifting the part above the remainder of the layer of the first powder;
removing the remainder of the layer of the first powder from the table;
adding a layer of a second powder to the table, wherein the second powder has a chemical composition different than the first powder;
disposing the new external cross section of the partially formed part in proximity with the layer of the second powder; and
selectively melting the second powder to fuse with the partially formed part.

18. The manufacturing process as recited in claim 17, further comprising heat treating the part with diffuse laser incidence during the adding, disposing and selectively melting steps.

19. An additive manufacturing machine comprising:
a table having a side for supporting a plurality of powdered particles thereon, the table being at least partially translucent; and
an energy beam source provided on a side of the table opposite the side for supporting the plurality of powdered particles.

20. The additive manufacturing machine as recited in claim 19, further comprising:
a base configured to have the plurality of powdered particles fused thereto; and
a lifting mechanism for selectively moving the base relative to the table.
